(19) United States
(12) Patent Application Publication
(10) Pub. No.: US 2025/0389593 A1
(43) Pub. Date: Dec. 25, 2025

(54) MATCHED TEMPERATURE PROBE TIP AND THERMOWELL

(71) Applicant: Rosemount Inc., Shakopee, MN (US)

(72) Inventors: Samuel V. HAARALA, Chaska, MN (US); Zachary M KAISER, Chaska, MN (US); John L REUVERS, Minneapolis, MN (US)

(21) Appl. No.: 18/753,436

(22) Filed: Jun. 25, 2024

(51) Int. Cl. G01K 1/143; G01K 1/16

(52) U.S. Cl. CPC G01K 1/143; G01K 1/16

(57) ABSTRACT

A temperature probe is mountable within a thermowell having an internal bore with an end having an end shape. The temperature probe includes a probe body configured to be mounted within the thermowell. A temperature sensitive element is disposed within the probe body and has an electrical characteristic that varies with temperature. An end cap is coupled to the probe body and has a surface contour that is shaped to match the end shape of the bore of the thermowell. A temperature measurement system employing the thermowell and the temperature probe having a geometrically matching end cap is also provided.

### BACKGROUND

Temperature probes are used in a variety of industries and environments to monitor the temperature of a substance or surface, such as a process fluid flowing in a process fluid conduit, such as a pipe. In certain industrial environments, a thermowell is disposed within the process fluid conduit or vessel to shield the temperature probe from various aspects of the process such as high fluid flow rates, high pressures, and/or corrosive process fluids.

The interface between a thermowell and a temperature probe has a variety of design considerations that should be considered for applicability to a particular operation. Among these considerations are accuracy, thermal operating range, and response time. A fast response time is relatively important in many high-precision industries such as pharmaceuticals, food and beverage production, and chemical processing. Providing a temperature monitoring system with an improved response time would allow such temperature systems to be used in more operations, and particularly operations that require fast response times.

### SUMMARY

A temperature probe is mountable within a thermowell having an internal bore with an end having an end shape. The temperature probe includes a probe body configured to be mounted within the thermowell. A temperature sensitive element is disposed within the probe body and has an electrical characteristic that varies with temperature. An end cap is coupled to the probe body and has a surface contour that is shaped to match the end shape of the bore of the thermowell. A temperature measurement system employing the thermowell and the temperature probe having a geometrically matching end cap is also provided.

### BRIEF DESCRIPTION OF THE DRAWINGS

FIG. 1A is a diagrammatic perspective view of a portion of a temperature probe in accordance with the prior art.

FIG. 1B is a diagrammatic sectional view of a temperature probe disposed within a thermowell in accordance with the prior art.

FIG. 2A is a perspective view of a temperature probe in accordance with an embodiment of the present invention.

FIG. 2B is an enlarged perspective view of an end of a temperature probe in accordance with and embodiment of the present invention.

FIG. 3A is a partial perspective view of a temperature probe end cap in accordance with an embodiment of the present invention.

FIG. 3B is a cross-sectional view of the end cap illustrated in FIG. 3A.

FIG. 4. is a cross-sectional view of a temperature probe disposed within a thermowell in accordance with an embodiment of the present invention.

FIG. 5 is a cross-sectional view of various thermowells profiles with which embodiments described herein can be used.

FIG. 6 is a block diagram of a temperature sensing system using a temperature probe in accordance with an embodiment of the present invention.

### DETAILED DESCRIPTION

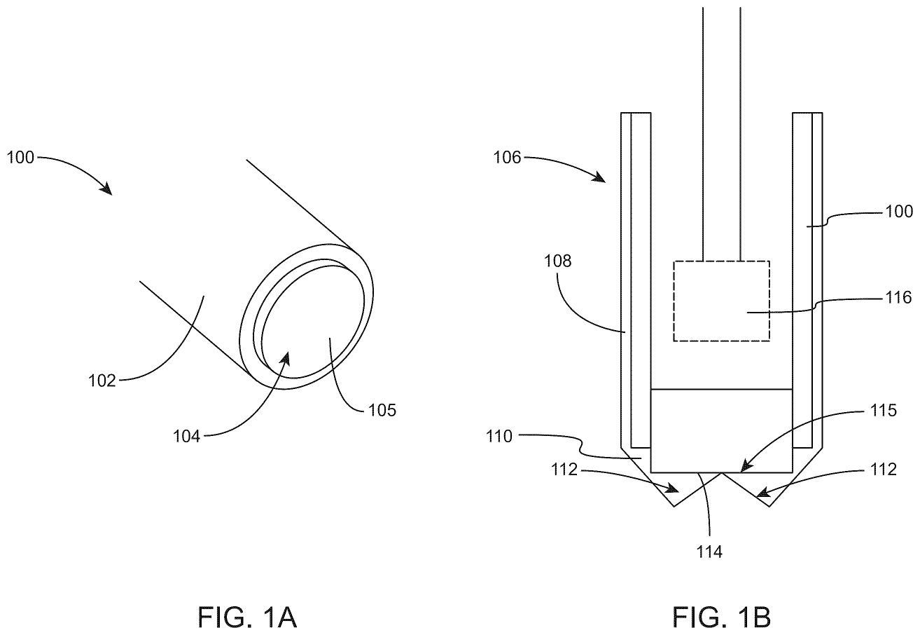

FIG. 1A is a diagrammatic perspective view of a portion of a temperature probe having an end cap in accordance with the prior art. Temperature probe 100 generally includes probe body 102 that has end cap 104. End cap 104 generally has a flat surface 105 at a distal end thereof.

FIG. 1B is a diagrammatic cross-sectional view of a portion of a temperature probe disposed within a thermowell in accordance with the prior art. Thermowell 106 generally includes sidewall 108 and distal end 110. The bore within sidewall 108 is typically formed by a gun drilling process. Gun drilling is utilized for its ability to precisely drill deep, narrow holes. Through the gun drilling process, the internal surface of distal end 110 is generally shaped as a ‘W’.

Thermowell 106 is generally inserted into the process fluid using a process intrusion created on the process equipment or pipeline. In most temperature measurement systems in which a temperature probe is needed to be protected from industrial processes, temperature probe 100 is disposed within thermowell 106.

Temperature probe 100 generally includes probe body 102 containing a temperature sensitive element 116 therein. Temperature sensitive element 116 is coupled to a pair of conductors 117 and has an electrical characteristic (e.g., resistance or emf) that varies with temperature. Examples of temperature sensitive element 116 include an RTD, a thermocouple, and a thermistor.

End cap 104 traditionally has a flat surface 105 located at its distal end. When temperature probe 100 is placed within thermowell 106, the physical contact between end cap 104 and internal surface 115 of distal end 110 is limited due to the mismatched surface geometries. Distal end 110 of thermowell 106 is generally ‘W’ shaped due to the gun drilling process. This limited contact generally leaves an air gap 112 between temperature probe 100 and internal surface 115 of the bottom of thermowell 106. This gap 112 and reduces thermal conduction between temperature probe 100 and distal end 115.

The surface matching limitation can result in measurement error and an undesirable increase in response time. The measuring accuracy of a temperature probe is highly dependent on thermal coupling between the respective process environment and the temperature probe. An accurate measurement is especially important when assessing a process fluid that has a composition that is sensitive to temperature. Further, the flat nature of end cap 104 and the limitation of surface area contact to distal end 115 allows temperature probe 100 to shake when thermowell 106 is under vibration due to process conditions. To attempt to overcome these limitations, the use of expensive high-conduction tips, thermal paste, and/or oil filled thermowells are known to be previously used in the field.

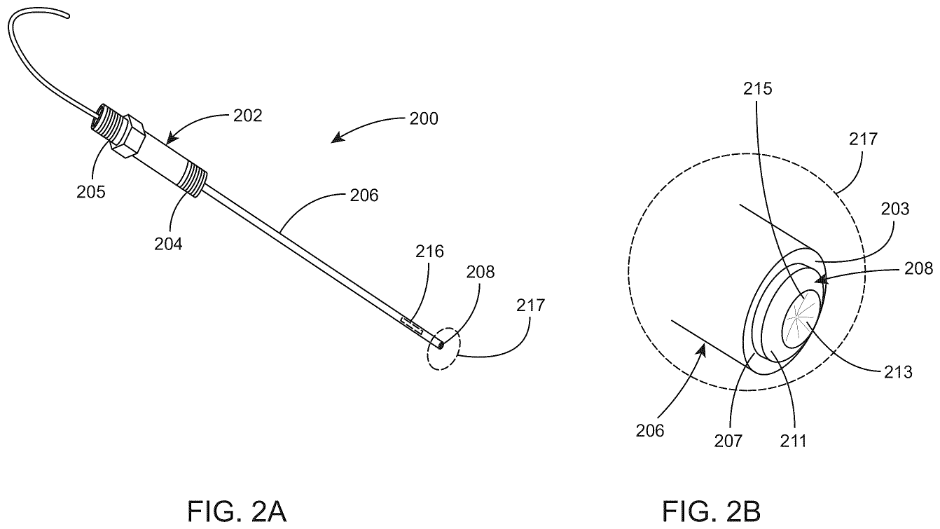

FIG. 2A is a perspective view of a temperature probe for sensing a temperature of a surface having a surface geometry according to one embodiment. Temperature probe 200 includes coupling member 202, temperature sensitive element 216 having an electrical characteristic that varies with temperature, and probe body 206. Coupling member 202 includes threads 204 or other suitable structure to couple to a thermowell. Additionally, coupling member 202 includes threads 205 or other suitable structure to couple to a transmitter electronics housing or other suitable device to relay temperature information to a remote device and/or display. Temperature sensitive element 216 may be any suitable component that has an electrical characteristic that varies with temperature, such as a thermocouple, resistive temperature detector (RTD), or thermistor, to detect temperature.

Probe body 206 and/or end cap 208 is/are generally cylindrical and constructed at least partially of a thermally conductive material. This material may include alloy metals or other metallic materials capable of conducting thermal energy. In one example, the thermally conductive material may be copper to further improve heat transfer and response time. Probe body 206 houses temperature sensitive element 216 and further includes or is coupled to end cap 208. In accordance with an embodiment of the present invention, end cap 208 is specifically shaped to match the surface geometry of the internal surface of a thermowell bottom. During fabrication of temperature probe 200, the shape of end cap 208 can be adjusted to adopt a specific contour required to geometrically match the surface. In one example, end cap 208 has a shape with a ‘W’ contour. End cap 208 can be formed as a separate component of probe 206 or may be formed integrally with probe 206.

FIG. 2B is an enlarged perspective view of an end of a temperature probe in accordance with and embodiment of the present invention. FIG. 2B is an enlarged view of region 217 shown in FIG. 2A. As can be seen, end cap 208 is generally cylindrically-shaped and mounted within the sidewall of probe body 206 thereby creating a shoulder 203. End cap 208 has a sidewall 207 that extends axially from shoulder 203. A first tapered surface 211 is formed adjacent sidewall 207 and extends inwardly from sidewall 207. A second tapered surface 213 meets first tapered surface 207 at apex ring 215. The size and slope of first tapered surface 211 and second tapered surface 213 are selected to match the shape of an end of a gun-drilled bore in a thermowell. In this way, thermal contact between the temperature probe and the thermowell is increased resulting in increased measurement accuracy and reduced sensor response time.

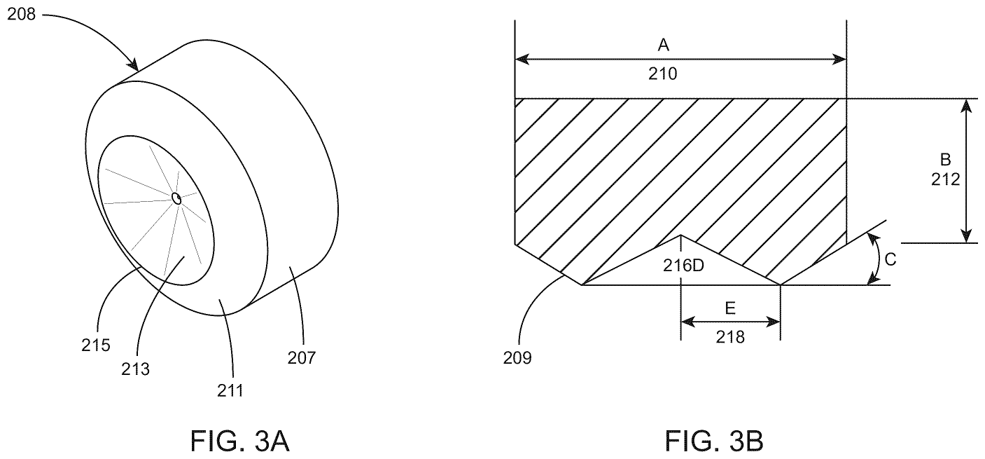

FIG. 3A is a perspective view of an end cap of a temperature probe in accordance with an embodiment of the present invention. End cap 208 has a shape with a specific contour to match the shape of an end of a gun-drilled bore in a thermowell. As can be seen, the shape of end cap 208 is selected to match an end of bore formed in a thermowell by a gun drill process.

In the illustrated example, end cap 208 has a shape with a ‘W’ contour 209 (shown in FIG. 3B). For example, end cap 208 may have a shape with a round contour to match a round contour of an internal bore of the thermowell. In another example, end cap 208 may have a shape with a flat contour as long as the end of the bore within the thermowell is machined or otherwise formed to be flat as well. In the case of a thermowell, the matched geometry of end cap 208 to the distal end of a thermowell may also reduce the vibration that the temperature probe may experience from surrounding process conditions. This is particularly so in embodiments that include at least one tapered surface (e.g., a ‘W’ shape) such that the contact between the end cap 208 and the thermowell can resist lateral (i.e., having a motion component in the radial direction of the end cap 208) vibration.

FIG. 3B is a cross-sectional view of an end cap of a temperature probe according to the end cap illustrated in FIG. 3A. End cap 208 includes a shape with a ‘W’ contour 209 which matches the surface geometry of a surface. End cap 208 may include diameter 210, length A, which is equal to the diameter of the probe body of a temperature probe. End cap 208 may have sidewall length B-212, that is dependent on the profile of the probe body. It is appreciated that length B corresponds to the length of the profile of the probe body. End cap 208 may have angle C-214, that reflects the outer angle formed by a gun drill point during the machining process. Angle 214 may be modified in accordance with the degree of the outer angle formed by the gun drill point. End cap 208 may have depth D-216, that corresponds to the depth of the gun drill point. End cap 208 may have radius 218, length E, which provides a reference measurement to form end cap point tips. Lengths A-E and angle C may be altered to accommodate the gun drill point feature of a given thermowell such that end cap 208 will geometrically match the surface geometry of a surface. End cap is generally mounted or affixed to the end of the cylindrical sidewall of probe body 206. This can be accomplished using known welding techniques, machining techniques (e.g., swaging), and/or adhesives.

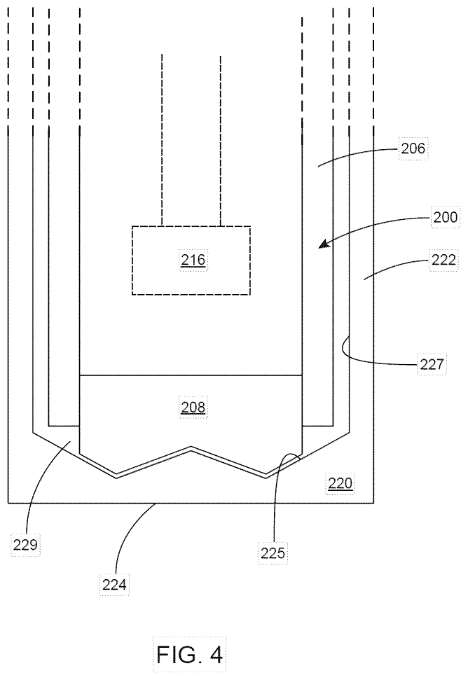

FIG. 4. is a cross-sectional view of a portion of a temperature probe disposed within a thermowell in accordance with an embodiment of the present invention. Thermowell 220 includes sidewall 222, distal end 224 with an end 225 of a bore 227 formed within thermowell 220, and an interior space 229 defined therein. Sidewall 222 generally has a cylindrical profile. Temperature probe 200 generally has a cylindrical shape and is sized to fit within sidewall 222 of thermowell 220. Temperature probe 200 includes temperature sensitive element 216 having an electrical characteristic that varies with temperature, and probe body 206. Probe body 206 houses temperature sensitive element 216 and further includes end cap 208. End cap 208 has a shape with a specific contour to match the surface geometry of a surface.

As shown in FIG. 4, end cap 208 has a surface contour or geometry that is configured to match that of end 225 within bore 227 of thermowell 200. Generally, the interior space of thermowell 220 is created through a gun drilling process. Through this gun drilling process, end 225 acquires a traditional ‘W’ shape contour formed by the gun drill point. In some embodiments, end cap 208 may be altered to geometrically match this ‘W’ shaped surface of end 225. The modified shape of end cap 208 allows end cap 208 to mate with end 225 of bore 227 such that the physical contact between end cap 208 and distal end 224 is increased. In this case, the matched geometry of end cap 208 to end 225 provides a more robust connection between temperature probe 200 and thermowell 220 as the lateral motion of temperature probe 200 is reduced when thermowell 220 experiences vibration from environmental conditions like mechanical forces produced by a process fluid.

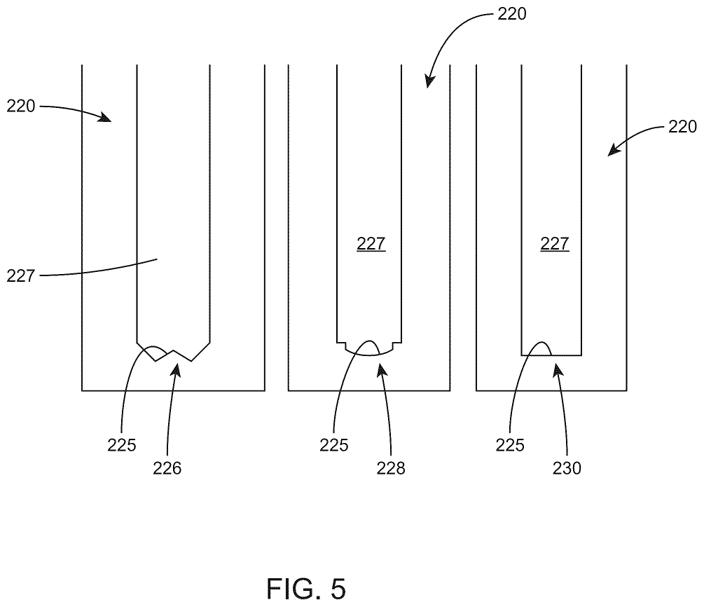

FIG. 5 is a diagrammatic frontal view of a thermowell having a profile with a distal end which has modified shape geometries. During the manufacture of thermowell 220 through a gun drilling process, the gun drill forms an internal bore 227 having end 225. The shape of end 225 adopts a specific geometry as a result of the gun drill point and gun drill process. Traditionally, the gun drill point forms an end 225 having a shape having a ‘W’ contour as illustrated at reference numeral 226. In one example, a subsequent machining process may be applied to alter the shape of end 225 of thermowell 220. The subsequent machining process may include utilizing an end mill action to remove flatten the ‘W’ contour of end 225. In another example, end 225 may adopt an alternate shape, such as a round contour 228. In another example, end 225 may adopt a shape with a flat contour 230 due to the subsequent end mill machining operation. It is appreciated that any variation of shape geometry may be given to end 225 of thermowell 220 through a subsequent machining operation. Additionally, the subsequent machining operation may include any milling process sufficient to alter the shape geometry of end 225. Accordingly, end cap 208 of temperature probe 200 is configured to geometrically match the surface contour of end 225.

As set forth above, end 225 of bore 227 within thermowell 220 may have a shape with a flat contour 230. In one example, the flat drill point feature of end 225 may be used as a projection weld feature to secure a temperature probe in place when end cap 208 of temperature probe 200 has a shape with a flat contour. The connection between the temperature probe and the thermowell is thus more secure and provides additional stability and measurement accuracy. Likewise, any variation of distal end shape may be used as a projection weld feature to secure a temperature probe having a corresponding end cap shape. The drill point feature of thermowell 220 may also be used as a mold to manufacture an end cap of a temperature probe, such that the end cap precisely matches.

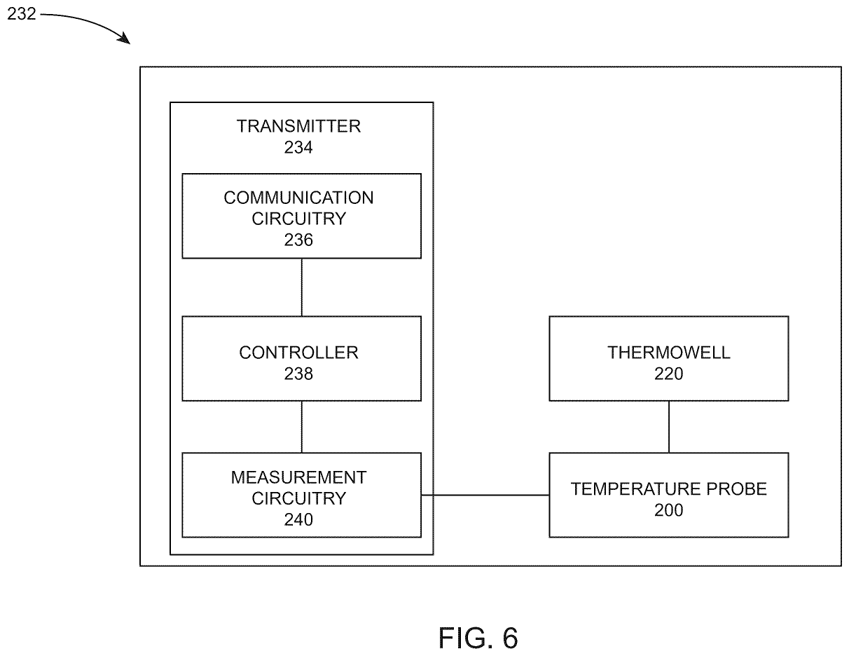

FIG. 6 is a block diagram of a temperature sensing system using a temperature probe in accordance with an embodiment of the present invention. Temperature measurement assemblies as discussed above may be electrically connected directly to a process control system or may be connected through temperature transmitters. The temperature measurement system 232 may include transmitter 234 which includes communication circuitry 236, controller 238, and measurement circuitry 240. In one example, measurement circuitry 240 may be used to convert measure the electrical characteristic of the temperature sensitive element 216 within temperature probe 200 and provide a digital indication thereof to controller 238. Accordingly, controller 238 may receive this temperature information from measurement circuitry 240 and further produce a temperature output. Communication circuitry 236 may receive the temperature output from controller 238 and transmit the output to a remote device.

Temperature probe 200 includes a temperature sensitive element having an electrical characteristic that varies with temperature. Temperature probe 200 also includes an end cap that geometrically matches a surface contour or shape of an internal end of a thermowell within which the temperature probe 200 will be mounted. In one example, temperature probe 200 is disposed within thermowell 220 to determine the temperature of a process fluid. In this case, thermowell 220 may be positioned within a process fluid conduit or pipeline. Accordingly, an accurate measurement and quick response time may be especially important with fluid whose quality is sensitive to temperature.

Temperature probe 200 may be detachably coupled to thermowell 220 through a coupling member or connection element. Temperature probe 200 may have a probe body that houses the temperature sensitive element. The probe body may have an end cap which is manufactured to geometrically match the surface of a distal end of thermowell 220. The end cap ultimately mates with the surface geometry of the distal end. In one example, the distal end may have a shape with a ‘W’ contour, formed by a gun drill point. The distal end may also be altered through the application of a subsequent machining process, such as an end mill action. Accordingly, the end cap has a shape to geometrically match the surface geometry of the distal end to provide an increase in surface area contact to increase the accuracy and response time of the temperature measurement system.

Although the present invention has been described with reference to preferred embodiments, workers skilled in the art will recognize that changes may be made in form and detail without departing from the spirit and scope of the invention.

What is claimed is:

1. A temperature probe mountable within a thermowell having an internal bore with an end having an end shape, the temperature probe comprising:
a probe body configured to be mounted within the thermowell;
a temperature sensitive element within the probe body, the temperature sensitive element having an electrical characteristic that varies with temperature; and
an end cap coupled to the probe body, the end cap having a surface contour that is shaped to match the end shape of the bore of the thermowell.

2. The temperature probe of claim 1, wherein the surface contour is a ‘W’.

3. The temperature probe of claim 1, wherein the surface contour is flat.

4. The temperature probe of claim 1, wherein the surface contour is round.

5. The temperature probe of claim 1, wherein the probe body is at least partially made of a thermally conductive material.

6. The temperature probe of claim 1, wherein the probe body has a cylindrical shape.

7. The temperature probe of claim 1, wherein the probe body includes a coupling element.

8. A temperature measurement assembly comprising:
a thermowell having a sidewall, a distal end, and an interior space defined therein, the thermowell having a bore within the sidewall having an end with a surface contour; and
a temperature probe comprising:
a probe body be disposed within the bore of the thermowell;
an end cap coupled to the probe body and having a shape that matches the surface contour of the end of the bore of the thermowell; and
a temperature sensitive element disposed within the probe body, the temperature sensitive element having an electrical characteristic that varies with temperature.

9. The temperature measurement assembly of claim 8, wherein the end cap is welded to the distal end.

10. The temperature measurement assembly of claim 8, wherein the bore of the thermowell is formed by a gun drill.

11. The temperature measurement assembly of claim 10, wherein the surface contour of the end of the bore of the thermowell has a ‘W’ contour.

12. The temperature measurement assembly of claim 8, wherein the end cap has a flat surface adjacent to the distal end.

13. The temperature measurement assembly of claim 8, wherein the end cap has a round shape.

14. The temperature measurement assembly of claim 8, wherein the end cap is configured to reduce lateral movement of the temperature probe.

15. A temperature measurement system comprising:
a thermowell having a sidewall, a distal end, and an interior space defined therein, the thermowell having a bore within the sidewall having an end with a surface contour;
a temperature probe comprising:
a probe body be disposed within the bore of the thermowell;
an end cap coupled to the probe body and having a shape that matches the surface contour of the end of the bore of the thermowell;
a temperature sensitive element disposed within the probe body, the temperature sensitive element having an electrical characteristic that varies with temperature; and
a temperature transmitter comprising:
a measurement circuitry coupled to the temperature sensitive element, the measurement circuitry being configured to measure an electrical characteristic of the temperature sensitive element and provide a digital indication thereof;
a controller coupled to the measurement circuitry and configured to receive the digital indication and produce a temperature output; and
communication circuitry coupled to the controller and configured to transmit the temperature output to a remote device.

16. The temperature measurement system of claim 15, wherein the end cap has a ‘W’ shaped surface geometry.

17. The temperature measurement system of claim 15, wherein the bore within the thermowell is formed by a gun drill.

18. The temperature measurement system of claim 15, wherein the temperature probe is detachably coupled to the thermowell.

19. The temperature measurement system of claim 15, wherein the temperature probe is detachable coupled to the temperature transmitter.
